(19) United States
(12) Patent Application Publication
(10) Pub. No.: US 2010/0289375 A1
(43) Pub. Date: Nov. 18, 2010

(54) Stator Core

(76) Inventors: Alex Horng, Kaohsiung (TW); Tso-Kuo Yin, Kaohsiung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/466,458

(22) Filed: May 15, 2009

(51) Int. Cl. H02K 1/16

(52) U.S. Cl. 310/216.066

(57) ABSTRACT

A stator core includes a magnetically conductive member coated with an insulating layer. The magnetically conductive member is integrally formed as a single continuous monolithic piece. The magnetically conductive member includes a ring, a plurality of pole teeth, and a plurality of magnetic pole portions. The ring has an inner periphery defining a compartment. Each pole tooth includes a first end contiguous to the inner periphery of the ring and a second end extending in the compartment. Each magnetic pole portion is contiguous to the second end of one of the pole teeth. The stator core can be utilized to form a stator for an inner rotor motor. Each pole tooth can include arcuate guide portions to allow easy winding of coils.

### BACKGROUND OF THE INVENTION

1. Field of the Invention

The present invention relates to a stator core and, more particularly, to a stator core for a motor having a simplified structure while allowing easy assembly.

2. Description of the Related Art

FIGS. 1 and 2 show a conventional stator core 8 including a plurality of silicon steel plates 81 and two insulating caps 82. Each silicon steel sheets 81 is formed by pressing and includes a ring 811 and a plurality of arms 812 extending radially inward from an inner periphery of the ring 811. Each arm 812 has a distal end with a magnetic pole face 813. The silicon steel plates 81 are stacked up, and the insulating caps 82 are coupled to two ends of the stacked silicon steel sheets 81. Each insulating cap 82 includes a plurality of extensions 821 aligned with the arms 812. A plurality of enamel insulated wires 83 are wound around the arms 812 and the extensions 821 to a predetermined turns to form a stator. The stator can be coupled with a rotor and a base (not illustrated) to form a motor. The insulating caps 82 not only provide insulating effect between the silicon steel sheets 81 and the enamel insulated wires 83 but protect the enamel insulated wires 83. However, the insulating caps 82 are problems in the trend of miniaturization of motors. Specifically, the insulating caps 82 increase the axial length of the stator core 8 and, thus, increase the overall volume and the overall axial length of the motor utilizing the stator core 8. Furthermore, stacking of the silicon steel sheets 81 is not easy, and mounting the insulating caps 82 to the ends of the stacked silicon steel sheets 81 is more difficult. Further, the resultant stator core 8 is complicated in structure. Thus, the stator core 8 is not economic.

FIGS. 3 and 4 show a conventional stator core 9 disclosed in Taiwan Patent Publication No. I299601 entitled “MOTOR ROTOR”. The stator core 9 includes a central hollow mounting portion 91 and a plurality of pole arms 92 extending radially outward from an outer periphery of the mounting portion 91. A magnetically attracting member 921 is formed on a distal end of each pole arm 92. The stator core 9 is integrally formed, and a recessed portion 93 is formed between the mounting portion 91 and each magnetically attracting member 921. A coil (not illustrated) is wound in each recessed portion 93 to accomplish winding. More turns can be obtained for each coil without changing the axial length of the stator due to provision of the recessed portions 93. However, the recessed portions 93 do not provide a structure for centralizing, guiding, and effectively positioning the coils. Specifically, the coils can not be effectively centralized on a middle portion of each pole arm 92 during the winding procedure, leading to difficulties in winding. Furthermore, the coils may not be effectively positioned in determined portions of the stator core 9 during or after winding. Namely, tools for positioning the coils are required. Further, the problems of increased overall axial length and complicated assembly of the stator core 9 are incurred when insulating caps are utilized. Further, the stator core 9 does not provide increased cross sectional area for magnetic paths in the adjoining area A between each pole arm 92 and each magnetically attracting member 921 and in the adjoining area B between the mounting portion 91 and each pole arm 92. Thus, the magnetic hysteresis in the adjoining areas A and B can not be effectively reduced.

Aside from poor rotational stability and low speed, outer rotor motors could not meet the heat dissipating demands of current electronic products having a trend in high speed, function integrity, and miniaturization. Thus, more and more electronic products utilize inner rotor motors to drive the heat dissipating fans. However, instead of applications of the stator core 9 in inner rotor motor, the stator core 9 including the pole arms 92 radially outward of the mounting portion 91 can only be utilized in the stator structure for an outer rotor motor.

### SUMMARY OF THE INVENTION

The primary objective of the present invention is to provide a stator core that can be easily assembled and that has a simple structure.

Another objective of the present invention is to provide a stator core to effectively position the coils in predetermined positions during or after the winding procedure.

Another objective of the present invention is to provide a stator core to effectively reduce the magnetic hysteresis.

Another objective of the present invention is to provide a stator core for centralizing and guiding the coils to allow easy winding.

Another objective of the present invention is to provide a stator core to effectively reduce an axial length of the stator core.

Another objective of the present invention is to provide a stator core without insulating caps.

In a preferred form, a stator core according to the preferred teachings of the present invention includes a magnetically conductive member coated with an insulating layer. The magnetically conductive member is integrally formed as a single continuous monolithic piece. The magnetically conductive member includes a ring, a plurality of pole teeth, and a plurality of magnetic pole portions. The ring has an inner periphery defining a compartment. Each pole tooth includes a first end contiguous to the inner periphery of the ring and a second end extending in the compartment. Each magnetic pole portion is contiguous to the second end of one of the pole teeth. The stator core can be utilized to form a stator for an inner rotor motor, simplifying the structure, allowing easy assembly, and reducing the overall axial length.

In a preferred form, the ring includes first and second end faces spaced along a longitudinal axis of the ring. The inner periphery of the ring extends between the first and second end faces. The magnetically conductive member includes a plurality of positioning protrusions formed on at least one of the first and second end faces.

Preferably, each pole tooth includes an arcuate guide section between the ring and each magnetic pole portion. Each pole tooth extends in a radial direction perpendicular to the longitudinal axis. Each pole tooth includes first and second lateral sides spaced in a direction perpendicular to the radial direction. In a preferred form, each arcuate guide section is formed on each of the first and second lateral sides to allow easy winding when winding coils on the pole teeth. Preferably, each of the first and second lateral sides of each pole tooth has an adjoining section between the ring and one of the pole teeth, and each arcuate guide section is formed at one of the adjoining sections. Preferably, each of the first and second lateral sides of each pole tooth has an adjoining section between one of the pole teeth and one of the magnetic pole portions, and each arcuate guide section is formed at one of the adjoining sections. The arcuate guide sections effectively guide each coil to a middle portion of one of the pole teeth, enhancing winding convenience. In another preferred form, each pole tooth includes first and second surfaces spaced in the longitudinal direction, and each arcuate guide section is formed on each of the first and second surfaces. Preferably, each of the first and second surfaces of each pole tooth has an adjoining section between the ring and one of the pole teeth, and each arcuate guide section is formed at one of the adjoining sections. Preferably, each of the first and second surfaces of each pole tooth has an adjoining section between one of the pole teeth and one of the magnetic pole portions, and each arcuate guide section is formed at one of the adjoining sections. The arcuate guide sections effectively guide the coils to a middle portion of one of the pole teeth, enhancing winding convenience.

In another preferred form, a stator core according to the preferred teachings of the present invention includes a magnetically conductive member integrally formed as a single continuous monolithic piece. The magnetically conductive member includes a ring, a plurality of pole teeth, and a plurality of magnetic pole portions. The ring has an inner periphery defining a compartment. Each pole tooth includes a first end contiguous to the inner periphery of the ring and a second end extending in the compartment. Each magnetic pole portion is contiguous to the second end of one of the pole teeth. The magnetically conductive member can be coated with an insulating layer. Furthermore, protrusions can be formed on at least one of two end faces of the ring.

The present invention will become clearer in light of the following detailed description of illustrative embodiments of this invention described in connection with the drawings.

### BRIEF DESCRIPTION OF THE DRAWINGS

The illustrative embodiments may best be described by reference to the accompanying drawings where:

FIG. 1 shows an exploded, perspective view of a conventional stator core.

FIG. 2 shows a perspective view of the stator core of FIG. 1.

FIG. 3 shows a perspective view of another conventional stator core.

FIG. 4 shows distribution of magnetic force of the stator core of FIG. 3.

FIG. 5 shows a perspective view of a stator core of a first embodiment according to the preferred teachings of the present invention.

FIG. 6 shows a top, cross sectional view of the stator core of FIG. 5.

FIG. 7 shows distribution of magnetic force of the stator core of FIG. 5.

FIG. 8 shows a perspective view of a stator core of a second embodiment according to the preferred teachings of the present invention with a portion of the stator core broken away.

FIG. 9 shows a side, cross sectional view of the stator core of FIG. 8.

FIG. 10 shows a perspective view of a stator core of a third embodiment according to the preferred teachings of the present invention.

FIG. 11 shows a top view of the stator core of FIG. 10 during winding of coils.

FIG. 12 shows a top view of the stator core of FIG. 10 after winding of coils.

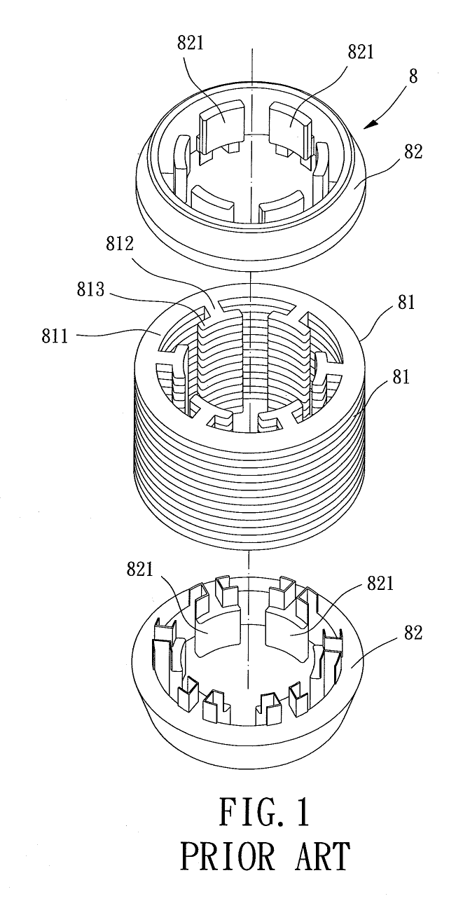

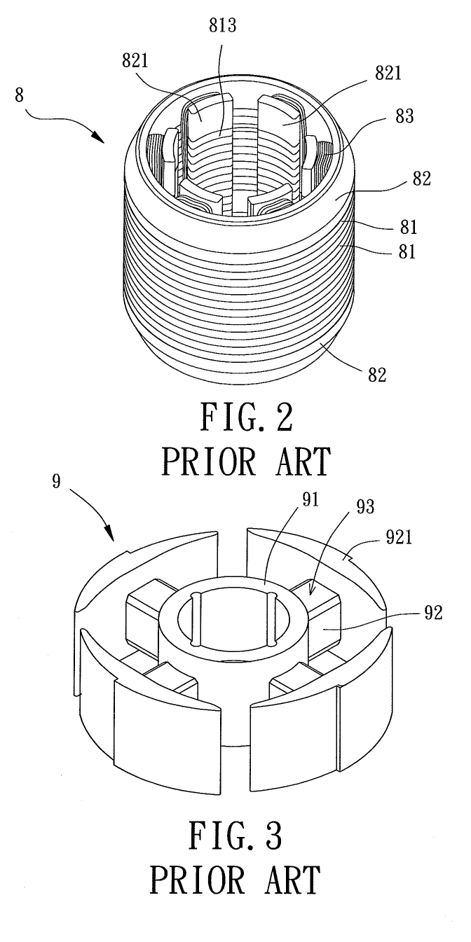

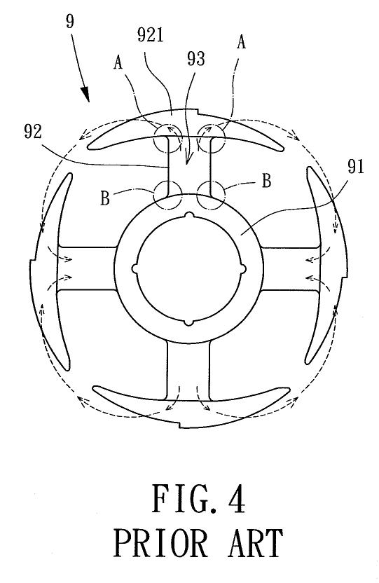

All figures are drawn for ease of explanation of the basic teachings of the present invention only; the extensions of the figures with respect to number, position, relationship, and dimensions of the parts to form the preferred embodiments will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

Where used in the various figures of the drawings, the same numerals designate the same or similar parts. Furthermore, when the terms “first”, “second”, “inner”, “outer”, “end”, “portion”, “section”, “longitudinal”, “axial”, “radial”, “lateral”, “annular”, “inward”, “length”, and similar terms are used herein, it should be understood that these terms have reference only to the structure shown in the drawings as it would appear to a person viewing the drawings and are utilized only to facilitate describing the invention.

### DETAILED DESCRIPTION OF THE INVENTION

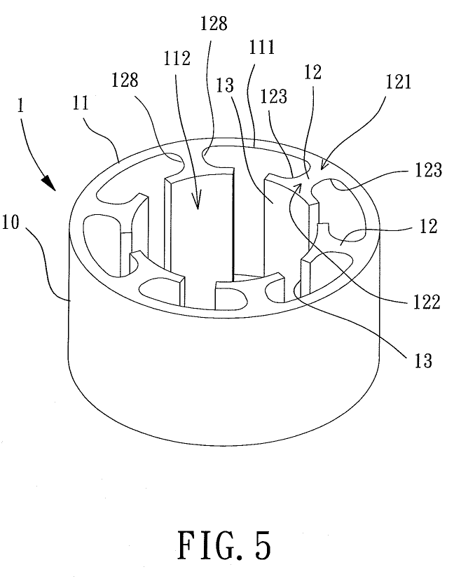

A stator core of a first embodiment according to the preferred teachings of the present invention is shown in FIGS. 5-7 of the drawings and designated as “1”. The stator core 1 includes a magnetically conductive member 10 integrally formed as a single continuous monolithic piece. The magnetically conductive member 10 is coated with an insulating layer 20 by electroplating or other suitable provisions.

The magnetically conductive member 10 includes a ring 11, a plurality of pole teeth 12, and a plurality of magnetic pole portions 13. The ring 11 is annular and has an inner periphery 111 defining a compartment 112. Each pole tooth 12 includes a first end 121 contiguous to the inner periphery 111 of the ring 11 and a second end 122 extending in the compartment 112. The pole teeth 12 are annularly spaced at regular intervals and each extend in a radial direction perpendicular to a longitudinal axis of the ring 11. Each magnetic pole portion 13 is contiguous to the second end 122 of one of the pole teeth 12. Each pole tooth 12 includes first and second lateral sides 128 spaced in a direction perpendicular to the radial direction.

Each pole tooth 12 includes an arcuate guide section 123 between the ring 11 and each magnetic pole portion 13. Each arcuate guide section 123 is formed on each of the first and second lateral sides 128. Each of the first and second lateral sides 128 of each pole tooth 12 has a first adjoining section C between the ring 11 and one of the pole teeth 12. Each of the first and second lateral sides 128 of each pole tooth 12 has a second adjoining section D between one of the pole teeth 12 and one of the magnetic pole portions 13. Each arcuate guide section 123 is formed at each of the first and second adjoining sections C and D.

Due to provision of the insulating layer 20 coated on the integrally formed magnetically conductive member 10, the inconvenient assembly encountered in stacking the silicon steel sheets for forming a stator core in the conventional designs can be avoided. Furthermore, the insulating layer 20 is much thinner than the insulating caps utilized in the conventional stator cores, reducing the overall axial length along the longitudinal axis of the ring 11. Thus, the stator core 1 according to the preferred teachings of the present invention can be utilized in various motors and meet the trend of miniaturization while simplifying the structure of the stator core 1 and enhancing assembling convenience.

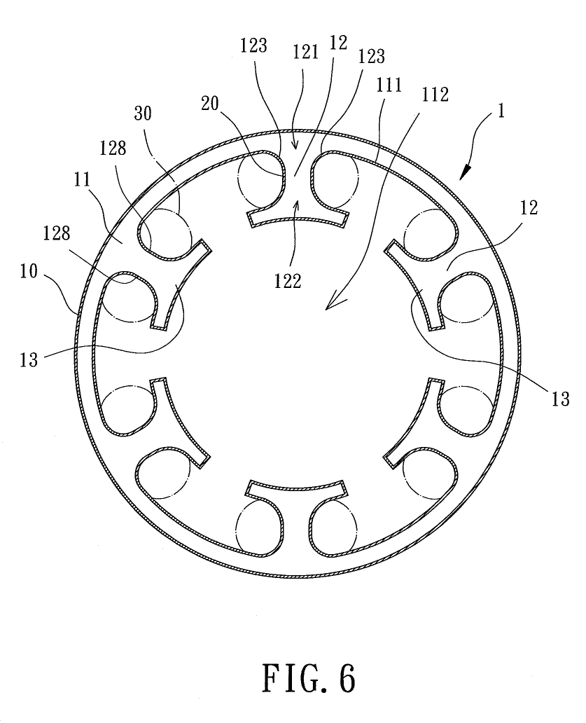

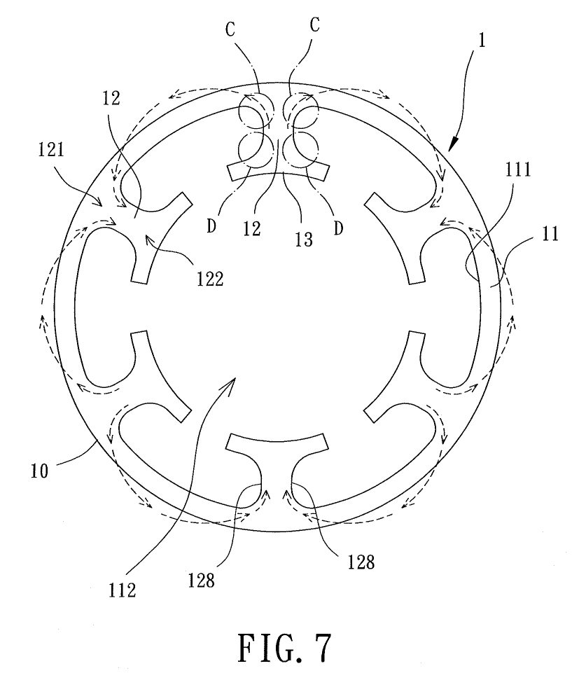

With reference to FIGS. 6 and 7, when winding coils 30 on the pole teeth 12, the arcuate guide sections 123 effectively guide the coils 30 so that each coil 30 can be concentrated on a middle portion of one of the pole teeth 12, enhancing winding convenience. Furthermore, when the arcuate guide sections 123 are formed on at least one of the first and second adjoining sections C and D, the structural strength of the at least one of the first and second adjoining sections C and D is enhanced.

Furthermore, due to provision of the arcuate guide sections 123 on at least one of the first and second adjoining sections C and D, the cross sectional areas of the magnetic paths at the first and/or second adjoining sections C and D can be increased. Thus, the hysteresis at the first or second adjoining sections C and D can be reduced when the stator core 1 according to the preferred teachings of the present invention creates magnetic force lines due to energization of the coils 30 (FIG. 7).

With reference to FIG. 5, since the pole teeth 12 and the magnetic pole portions 13 are located in the compartment 112 of the stator core 1 according to the preferred teachings of the present invention, the stator formed after winding the coils 30 around the pole teeth 12 can be coupled with a rotor, and a permanent magnet of the rotor is located in the compartment 112 and faces each magnetic pole portion 13. Thus, the stator core 1 according to the preferred teachings of the present invention can be utilized to form a stator for an inner rotor motor.

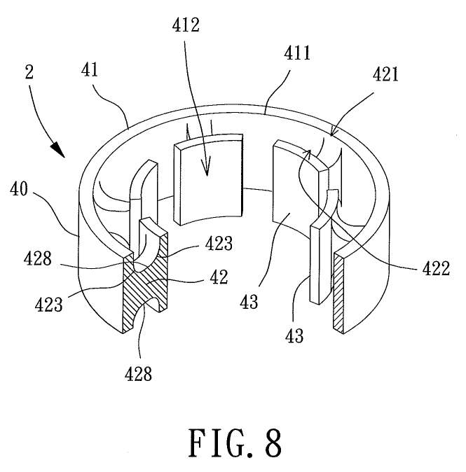

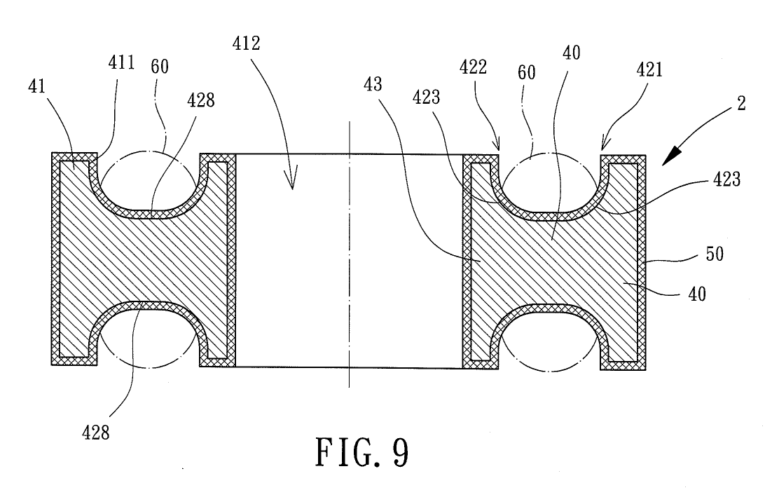

A stator core of a second embodiment according to the preferred teachings of the present invention is shown in FIGS. 8 and 9 and designated as “2”. The stator core 2 includes a magnetically conductive member 40 integrally formed as a single continuous monolithic piece. The magnetically conductive member 40 is coated with an insulating layer 50 by electroplating or other suitable provisions.

The magnetically conductive member 40 includes a ring 41, a plurality of pole teeth 42, and a plurality of magnetic pole portions 43. The ring 41 is annular and has an inner periphery 411 defining a compartment 412. Each pole tooth 42 includes a first end 421 contiguous to the inner periphery 411 of the ring 41 and a second end 422 extending in the compartment 412. The pole teeth 42 are annularly spaced at regular intervals and each extend in a radial direction perpendicular to a longitudinal axis of the ring 41. Each magnetic pole portion 43 is contiguous to the second end 422 of one of the pole teeth 42. Each pole tooth 42 includes first and second surfaces 428 spaced in the longitudinal direction of the ring 41.

Each pole tooth 42 includes an arcuate guide section 423 between the ring 41 and each magnetic pole portion 43. Each arcuate guide section 423 is formed on each of the first and second surfaces 428. Each of the first and second surfaces 428 of each pole tooth 42 has a first adjoining section between the ring 41 and one of the pole tooth 42 and a second adjoining section between one of the pole teeth 42 and one of the magnetic pole portions 43, and each arcuate guide section 423 is formed at one of the first and second adjoining sections. Coils 60 can be wound around the pole teeth 42 due to provision of the arcuate guide sections 423.

Similar to the first embodiment, the overall axial length is reduced, the structure is simplified, and the assembling procedure is easier due to provision of the thin insulating layer 50 coated on the integrally formed magnetically conductive member 40. Furthermore, by providing the arcuate guide sections 423 in the first and second surfaces 428 of each pole tooth 42 spaced in the longitudinal direction of the ring 41, the coils 60 can be effectively centralized on the middle portion of each pole tooth 42, enhancing winding convenience.

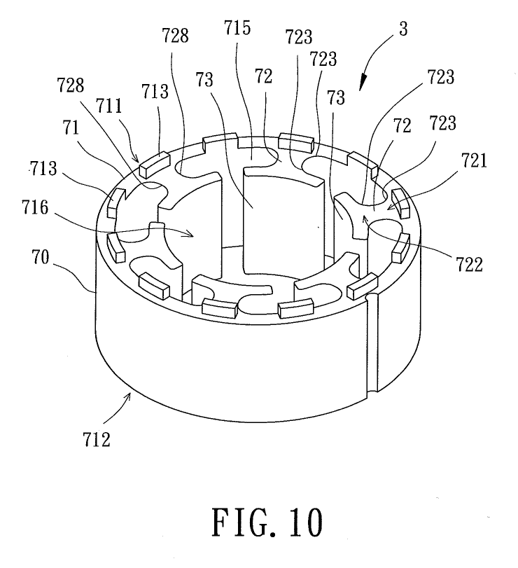

A stator core of a third embodiment according to the preferred teachings of the present invention is shown in FIGS. 10-12 and designated as “3”. The stator core 3 includes a magnetically conductive member 70 integrally formed as a single continuous monolithic piece. The magnetically conductive member 70 can be coated with an insulating layer by electroplating or other suitable provisions.

The magnetically conductive member 70 includes a ring 71, a plurality of pole teeth 72, and a plurality of magnetic pole portions 73. The ring 71 is annular and has an inner periphery 715 defining a compartment 716. The ring 71 includes a longitudinal axis and first and second end faces 711 and 712 spaced along the longitudinal axis. The inner periphery 715 of the ring 71 extends between the first and second end faces 711 and 712. Each pole tooth 72 includes a first end 721 contiguous to the inner periphery 715 of the ring 71 and a second end 722 extending in the compartment 716. The pole teeth 72 are annularly spaced at regular intervals and each extend in a radial direction perpendicular to the longitudinal axis of the ring 71. Each magnetic pole portion 73 is contiguous to the second end 722 of one of the pole teeth 72. Each pole tooth 72 includes first and second lateral sides 728 spaced in a direction perpendicular to the radial direction. The magnetically conductive member 70 includes a plurality of positioning protrusions 713 formed on at least one of the first and second end faces 711 and 712. In the preferred form shown in FIGS. 10-12, the positioning protrusions 713 are formed on the first end face 711.

Each pole tooth 72 includes an arcuate guide section 723 between the ring 71 and each magnetic pole portion 73. Each arcuate guide section 723 is formed on each of the first and second lateral sides 728. Each of the first and second lateral sides 728 of each pole tooth 72 has a first adjoining section between the ring 71 and one of the pole teeth 72. Each of the first and second lateral sides 728 of each pole tooth 72 has a second adjoining section between one of the pole teeth 72 and one of the magnetic pole portions 73. Each arcuate guide section 723 is formed at each of the first and second adjoining sections.

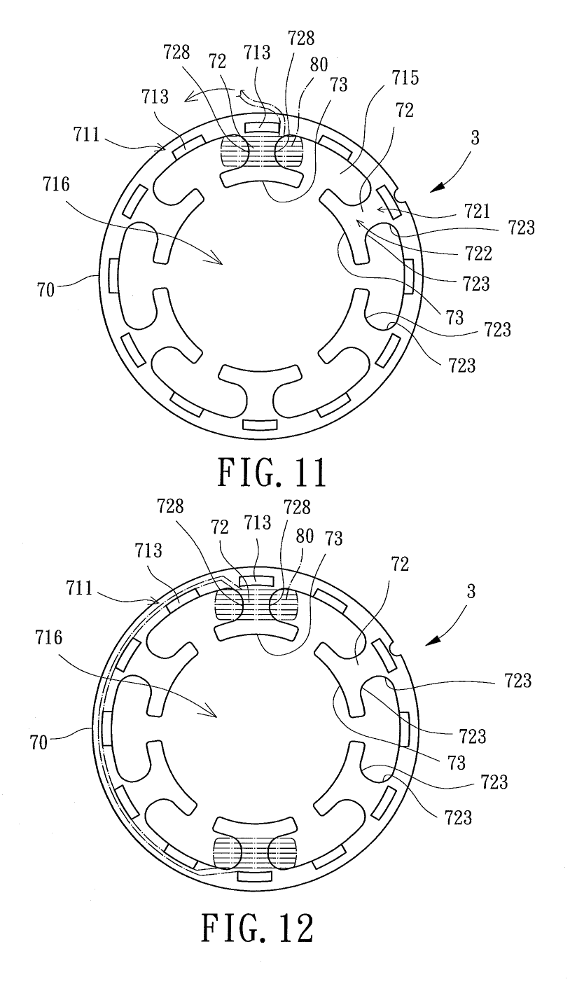

With reference to FIGS. 11 and 12, when winding coils 80 on the pole teeth 72, the coils 80 can be reliably positioned by the protrusions 713 to desired locations of the stator core 3. Specifically, when a coil 80 is wound around one of the pole teeth 72, the coil 80 can be easily wound around the next pole tooth 72 due to provision of the protrusions 713 (FIG. 11). After winding, the coil 80 can be reliably positioned by the outer faces of the protrusions 713.

The stator core 3 according to the preferred teachings of the present invention provides advantages the same as those provided by the first and second embodiments. Furthermore, the protrusions 713 provide a reliable positioning effect during and after the winding procedure. No positioning devices are required. The winding convenience is, thus, enhanced.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

What is claimed is:

1. A stator core comprising a magnetically conductive member coated with an insulating layer, with the magnetically conductive member integrally formed as a single continuous monolithic piece, with the magnetically conductive member including a ring, a plurality of pole teeth, and a plurality of magnetic pole portions, with the ring having an inner periphery defining a compartment, with each of the plurality of pole teeth including a first end contiguous to the inner periphery of the ring and a second end extending in the compartment, and with each of the plurality of magnetic pole portions contiguous to the second end of one of the plurality of pole teeth.

2. The stator core as claimed in claim 1, with the ring including a longitudinal axis and first and second end faces spaced along the longitudinal axis, with the inner periphery of the ring extending between the first and second end faces, and with the magnetically conductive member including a plurality of positioning protrusions formed on at least one of the first and second end faces.

3. The stator core as claimed in claim 2, with each of the plurality of pole teeth including an arcuate guide section between the ring and each of the plurality of magnetic pole portions.

4. The stator core as claimed in claim 3, with each of the plurality of pole teeth extending in a radial direction perpendicular to the longitudinal axis, with each of the plurality of pole teeth including first and second lateral sides spaced in a direction perpendicular to the radial direction, and with each of the arcuate guide sections formed on each of the first and second lateral sides.

5. The stator core as claimed in claim 4, with each of the first and second lateral sides of each of the plurality of pole teeth having an adjoining section between the ring and one of the plurality of pole teeth, and with each of the arcuate guide sections formed at one of the adjoining sections.

6. The stator core as claimed in claim 4, with each of the first and second lateral sides of each of the plurality of pole teeth having an adjoining section between one of the plurality of pole teeth and one of the plurality of magnetic pole portions, and with each of the arcuate guide sections formed at one of the adjoining sections.

7. The stator core as claimed in claim 3, with each of the plurality of pole teeth including first and second surfaces spaced in the longitudinal direction, and with each of the arcuate guide sections formed on each of the first and second surfaces.

8. The stator core as claimed in claim 7, with each of the first and second surfaces of each of the plurality of pole teeth having an adjoining section between the ring and one of the plurality of pole teeth, and with each of the arcuate guide sections formed at one of the adjoining sections.

9. The stator core as claimed in claim 7, with each of the first and second surfaces of each of the plurality of pole teeth having an adjoining section between one of the plurality of pole teeth and one of the plurality of magnetic pole portions, and with each of the arcuate guide sections formed at one of the adjoining sections.

10. A stator core comprising a magnetically conductive member integrally formed as a single continuous monolithic piece, with the magnetically conductive member including a ring, a plurality of pole teeth, and a plurality of magnetic pole portions, with the ring having an inner periphery defining a compartment, with each of the plurality of pole teeth including a first end contiguous to the inner periphery of the ring and a second end extending in the compartment, and with each of the plurality of magnetic pole portions contiguous to the second end of one of the plurality of pole teeth.

11. The stator core as claimed in claim 10, further comprising an insulating layer coated on the magnetically conductive member.

12. The stator core as claimed in claim 10, with the ring including a longitudinal axis and first and second end faces spaced along the longitudinal axis, with the inner periphery of the ring extending between the first and second end faces, with the magnetically conductive member including a plurality of positioning protrusions formed on at least one of the first and second end faces.
